(19) United States
(12) Patent Application Publication
(10) Pub. No.: US 2010/0064561 A1
(43) Pub. Date: Mar. 18, 2010

(54) AISLE-END SIGNAGE FRAME SYSTEM

(75) Inventor: Lucas Bradshaw, Fayetteville, AR (US)

Correspondence Address: The Caldwell Firm, LLC, P.O. Box 59655, Dallas, TX, 75229, US

(73) Assignee: A.W. BRAVIS AGENCY, LLC, Rogers, AR (US)

(21) Appl. No.: 12/209,425

(22) Filed: Sep. 12, 2008

(51) Int. Cl. G09F 15/00

(52) U.S. Cl. 40/606.01

(57) ABSTRACT

A system includes a display frame comprising a front panel, a first side panel, and a second side panel, and configured to receive a main display insert. A main display insert couples to the display frame and comprises a front display panel, a first side display panel, and a second side display panel. A first sidewall display unit couples to the first side panel of the display frame and receives a first signage insert. A second sidewall display unit couples to the second side panel of the display frame and receives a second signage insert.

### TECHNICAL FIELD

The present invention relates generally to the field of retail marketing and display and, more particularly, to an aisle-end signage frame system.

### BACKGROUND OF THE INVENTION

Modern retail environments, particularly supermarkets, typically employ supplemental shelving in addition to traditional aisle shelves. Typical aisle shelving comes in a wide variety of configurations. Most common supplemental shelving is configured to attach to either an end of an aisle or somewhere between the aisle-ends, but not both. Supplemental shelving also comes in a wide variety of configurations, one of which is the “Sidekick cage” configuration.

For example, FIG. 1 is a block diagram illustrating an exemplary Sidekick cage system 100 in accordance with the prior art. System 100 includes a display frame 110 configured to receive a display insert 120. As shown, display frame 110 includes a plurality of wire tines 112 arranged into a front panel 114 and two side panels 116.

The display insert 120 comprises a front display panel 124 and two side display panels 126, each of which can be suitably modified to hold products or product hangers. In typical systems, display insert 120 is a single, continuous piece of corrugated cardboard material, folded at the ends to form the side display panels. The display insert 120 usually includes graphics intended to promote the products offered in the display system.

In many retail environments, these aisle-end systems hold seasonal or sale items. As such, the retail operators change the display insert 120 graphics regularly. Because the typical display insert 120 is a simple cardboard component, it cannot be reprinted without prohibitive expense. In most cases, it is much less expensive to simply print a new display insert 120 with updated graphics.

While reprinting on display insert 120 is relatively inexpensive, many retail stores have several aisles, with one or more display systems at each end. For retail chains that change out the display inserts frequently, the cost of reprinting every display insert 120 can be substantial. Such reprinting also generates waste.

Additionally, changing each display insert 120 involves a time-consuming process. The operator must remove the displayed products, replace the display insert, and then replace the displayed products. For retail chains with many stores, the effort required to change out display inserts 120 can be very high.

Therefore, there is a need for a system and/or method for aisle-end signage frames that addresses at least some of the problems and disadvantages associated with conventional systems and methods.

### BRIEF SUMMARY

The following summary is provided to facilitate an understanding of some of the innovative features unique to the embodiments disclosed and is not intended to be a full description. A full appreciation of the various aspects of the embodiments can be gained by taking into consideration the entire specification, claims, drawings, and abstract as a whole.

A system includes a display frame comprising a front panel, a first side panel, and a second side panel, and configured to receive a main display insert. A main display insert couples to the display frame and comprises a front display panel, a first side display panel, and a second side display panel. A first sidewall display unit couples to the first side panel of the display frame and receives a first signage insert. A second sidewall display unit couples to the second side panel of the display frame and receives a second signage insert.

### BRIEF DESCRIPTION OF THE DRAWINGS

The accompanying figures, in which like reference numerals refer to identical or functionally-similar elements throughout the separate views and which are incorporated in and form a part of the specification, further illustrate the embodiments and, together with the detailed description, serve to explain the embodiments disclosed herein.

FIG. 1 illustrates a block diagram showing a common signage system in accordance with the Prior Art;

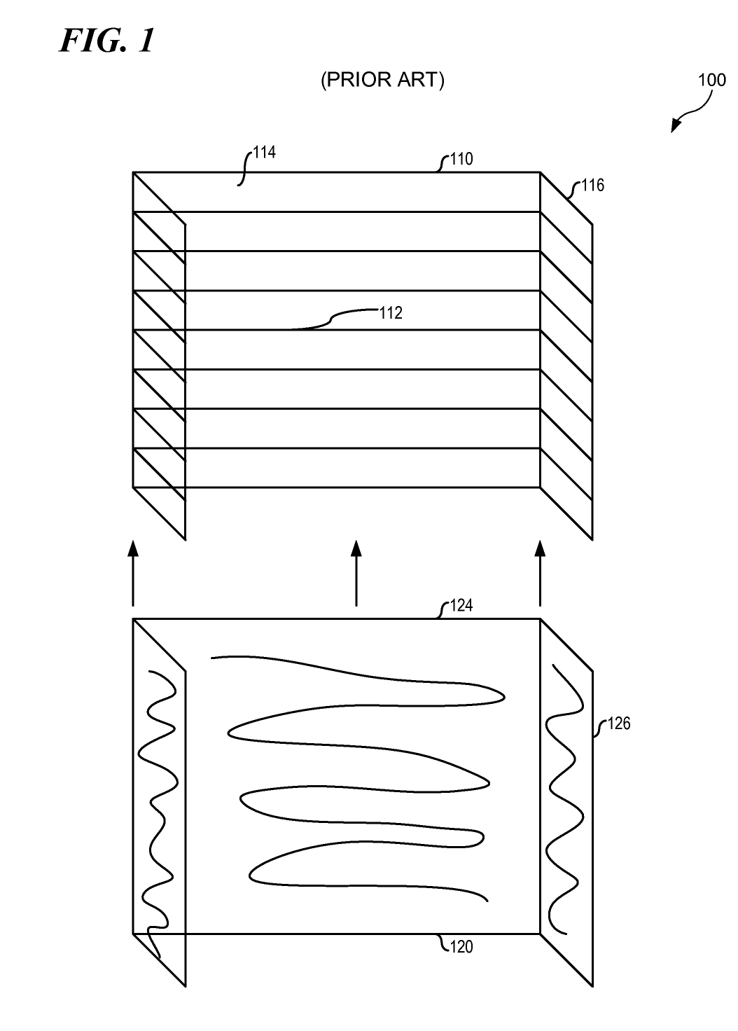

FIG. 2 illustrates a block diagram showing an improved aisle-end signage frame system in accordance with a preferred embodiment;

FIG. 3 illustrates a block diagram showing an improved aisle-end signage frame system in accordance with a preferred embodiment;

FIG. 4 illustrates a block diagram showing an improved aisle-end signage frame system in accordance with a preferred embodiment;

FIG. 5 illustrates a block diagram showing an improved aisle-end signage frame system in accordance with a preferred embodiment; and

FIG. 6 illustrates a block diagram showing an improved aisle-end signage frame system in accordance with a preferred embodiment.

### DETAILED DESCRIPTION

The particular values and configurations discussed in these non-limiting examples can be varied and are cited merely to illustrate at least one embodiment and are not intended to limit the scope of the invention.

In the following discussion, numerous specific details are set forth to provide a thorough understanding of the present invention. Those skilled in the art will appreciate that the present invention may be practiced without such specific details. In other instances, well-known elements have been illustrated in schematic or block diagram form in order not to obscure the present invention in unnecessary detail.

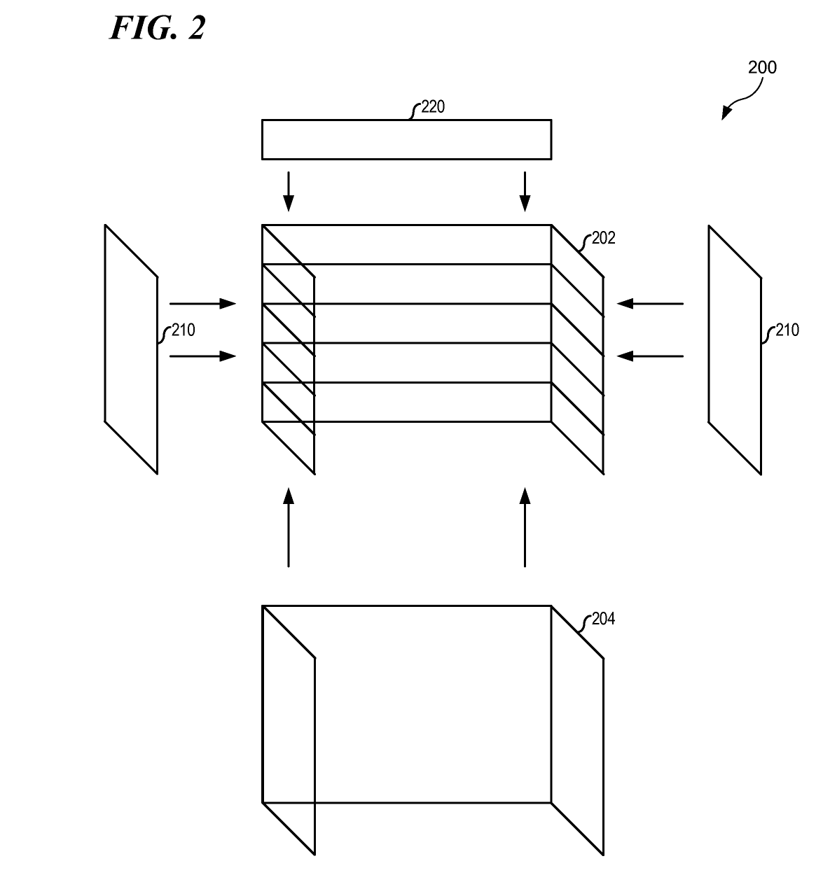

Referring now to the drawings, FIG. 2 is a high-level block diagram illustrating certain components of a display frame system 200, in accordance with a preferred embodiment of the present invention. As illustrated, system 200 includes an otherwise conventional display frame 202 configured to receive an otherwise conventional display insert 204.

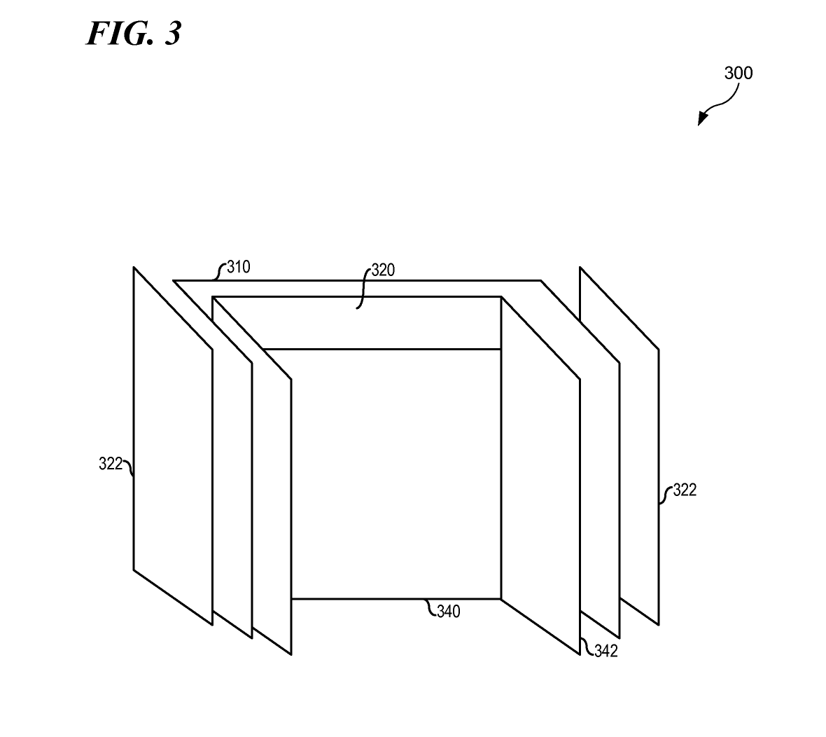

System 200 also includes two sidewall display units 210 and a top display unit 220. As illustrated, each sidewall display unit 210 couples to a side panel of display frame 202. The top display unit 220 couples to a top portion of display frame 202. FIG. 3 illustrates the components of system 200 coupled together in ordinary operation.

FIG. 3 is a high-level block diagram illustrating certain components of a display frame system 300, in accordance with a preferred embodiment of the present invention. As illustrated, system 300 includes an otherwise conventional display frame 310 configured to receive an otherwise conventional display insert 340.

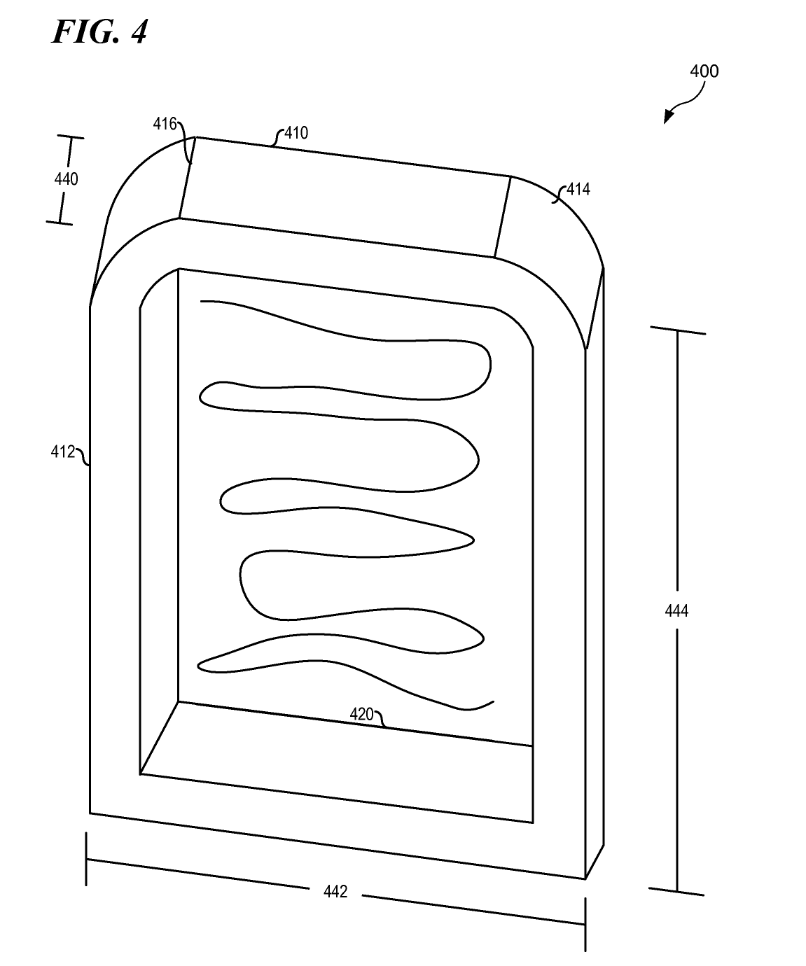

A top display unit 320 couples to display frame 310 and, in the illustrated embodiment, hangs over the top portion of display insert 340. Two sidewall display units 322 couple to the outside side panel of display frame 312. As illustrated, the sidewall display units 322 do not interfere with the graphics or other products on the display insert side panels 342. FIG. 4 illustrates a display unit in additional detail, in one embodiment.

FIG. 4 is a block diagram illustrating certain details of a display unit 400, in accordance with a preferred embodiment of the present invention. Display unit 400 can be configured as a sidewall display unit, such as sidewall display unit 210 of FIG. 2, for example. Display unit 400 can also be configured as a top display unit, such as top display unit 220 of FIG. 2, for example.

In the illustrated embodiment, display unit 400 includes a back panel 410. In the illustrated embodiment, back panel 410 is closed and continuous. In an alternate embodiment, back panel 410 is open. In an alternate embodiment, back panel 410 is partially open.

In the illustrated embodiment, display unit 400 includes a front overhang 412. In one embodiment, overhang 412 serves to secure a signage insert within display unit 400, as described below.

In the illustrated embodiment, display unit 400 includes rounded corners 414. Generally, rounded corners improve safety and can reduce injury in the event of accidental forceful contact with display unit 400.

In the illustrated embodiment, display unit 400 includes a top slot 416. Generally, top slot 416 is configured to receive a signage insert. In one embodiment, the signage insert is a graphics insert and display unit 400 is a graphics frame.

As described above, display unit 400 can be configured as a sidewall display unit or a top display unit. For example, display unit 400 comprises a depth 440, a width 442, and a height 444. Generally, in one embodiment, when configured as a sidewall display unit, height 444 is substantially greater than width 442. Generally, in one embodiment, when configured as a top display unit, width 442 is substantially greater than height 444. Generally, depth 440 can be based on the thickness of the expected signage insert. In one embodiment, depth 440 is the same for both a sidewall display unit and a top display unit.

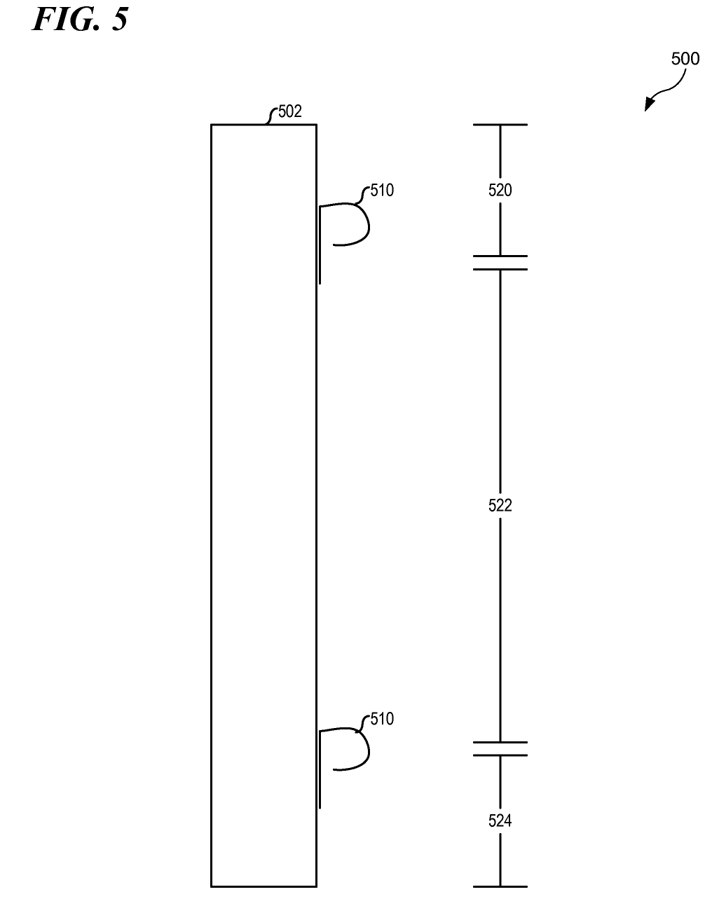

FIG. 5 is a block diagram illustrating a side view of a display unit 500. Generally, display unit 500 is a display unit such as sidewall display unit 210 or top display unit 220 of FIG. 2, or display unit 400 of FIG. 4, for example.

As illustrated, display unit 500 comprises a top slot 502. Generally, when coupled to a display frame, display unit 500 is oriented so that top slot 502 faces upwards (away from the direction of gravity). As shown, display unit 500 includes two coupling clips 510. In one embodiment, each coupling clip is configured to wrap around a wire tine, thereby securing the display unit 500 to a display frame. In one embodiment, each coupling clip is an otherwise conventional clip fastener configured to attach to a 0.25″ diameter wire.

Generally, coupling clips 510 are configured to clip to a wire tine. In an alternate embodiment, each coupling clip 510 is configured to affix to a display frame and can be a Velcro coupling, wire ties, or other suitable coupling mechanism.

Generally, a top coupling clip 510 is affixed to display unit 500 at a distance 520 from the opening of top slot 502. Distance 520 can vary based on the desired overhang of display unit 500 over the display from to which it is coupled.

Generally, a bottom coupling clip 510 is affixed to display unit 500 at a distance 522 along display unit 500 from the top coupling clip 510. Generally, distance 522 is selected to secure the bottom end of display unit 500 to the display frame and therefore need not be at the very end of the display unit 500. In one embodiment, bottom coupling lip 510 is affixes to display unit 500 at a distance 524 from the bottom of display unit 500.

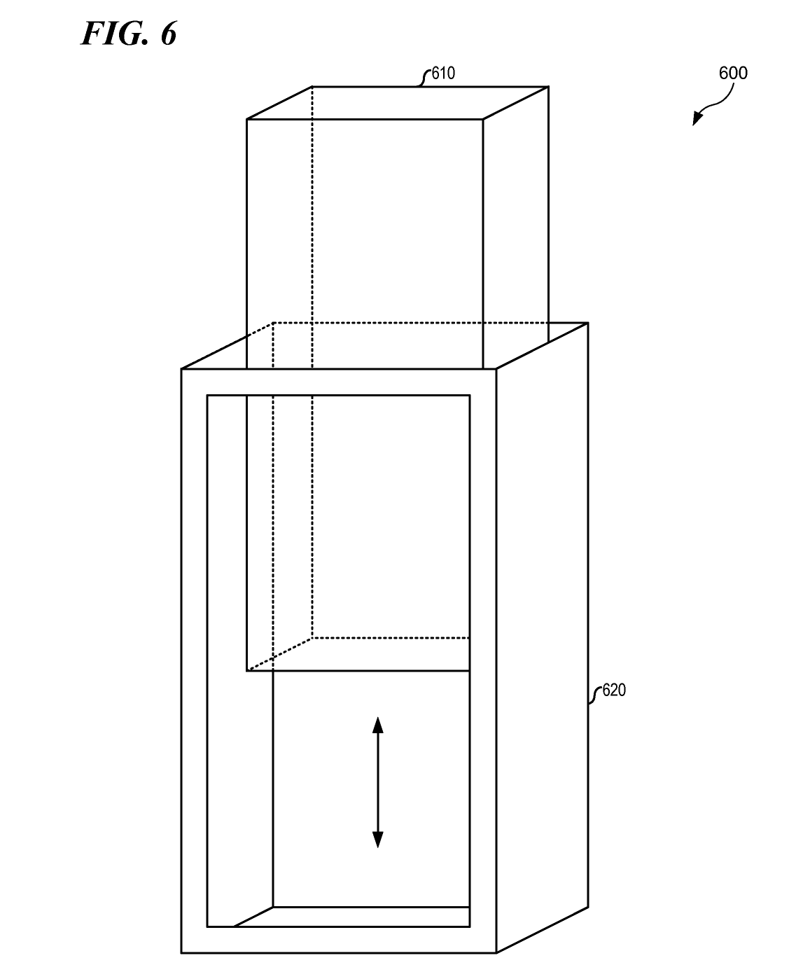

FIG. 6 is a block diagram illustrating operation of a display unit in accordance with one embodiment. Specifically, system 600 illustrates a graphics insert (a signage insert) 610 partway through insertion through the top slot of an open-back display unit 620. As shown, system 600 provides a sturdy frame to hold a replaceable signage insert. So configured, display unit 620 can be affixed to a display frame, providing the display frame with a relatively cost-effective customizable graphics frame system.

Accordingly, the disclosed embodiments provide numerous advantages over other methods and systems. For example, the aisle-end signage frame systems described herein provide a sturdy framework that can support replaceable graphics inserts. By replacing inexpensive graphics inserts, a retail operator can reduce the cost associated with exchanging a relatively costly full display insert. Additionally, the systems described herein are configured for rapid replacement of the graphics inserts, which reduces the time required to reconfigure aisle-end displays. As such, the systems described herein can also help a store communicate a consistent message and create a cleaner in-store appearance.

The embodiments disclosed herein also offer other advantages, especially over current methods and systems. For example, in some common systems, an average store in one large chain has 480 typical aisle-end stands. Each store receives new signage guidelines twelve times a year, and the cost to prepare typical signage (on poly plates) is around $1,400 per print plate set. As such, an average store employing the typical prior-art system incurs over $8 million in yearly print plate cost, which does not include the extra print and set-up cost for multi-color runs. Further, a typical prior art-plate set weighs approximately 30 pounds, and so the same store generates over 80 tons in print plates annually. Generally, these poly print plates are never used again, as a typical signage guideline is not ordinarily repeated.

But in the unique embodiments disclosed herein, a less expensive, lighter, more environmentally-friendly insert can be used, providing significant benefits. For example, the systems disclosed herein can reduce display production cost, reduce waste from display production, save money and the environment, help provide more cost effective displays, and help provide more sustainable signage programs. Moreover, the printing aspects of the signage are also affected as the signage can be gang run with minimal marginal cost. Altogether, the unique systems disclosed herein therefore significant advantages over prior art systems and methods.

The dimensions of an exemplary embodiment of the disclosed aisle-end signage frame system are:

| | |
|---|---|
| sidewall display unit height: | 48.0″ |
| sidewall display unit width: | 4.50″ |
| sidewall display unit depth: | 0.25″ |
| distance of the top clip from the display unit top: | 1.00″ |
| distance between the top clip and the bottom clip: | 46.75″ |
| distance between bottom clip and display unit bottom: | 1.00″ |
| clip inside diameter minimum: | 0.25″ |
| top display unit height: | 4.50″ |
| top display unit width: | 48.0″ |
| top display unit depth: | 0.25″ |

One skilled in the art will appreciate that variations of the above-disclosed and other features and functions, or alternatives thereof, may be desirably combined into many other different systems or applications. Additionally, various presently unforeseen or unanticipated alternatives, modifications, variations or improvements therein may be subsequently made by those skilled in the art, which are also intended to be encompassed by the following claims.

What is claimed is:

1. A system, comprising:
a display frame comprising a front panel, a first side panel, and a second side panel, and configured to receive a main display insert;
a main display insert coupled to the display frame and comprising a front display panel, a first side display panel, and a second side display panel;
a first sidewall display unit coupled to the first side panel of the display frame and configured to receive a first signage insert; and
a second sidewall display unit coupled to the second side panel of the display frame and configured to receive a second signage insert.

2. The system of claim 1, wherein the first sidewall display unit and the second sidewall display unit each further comprise rounded corners.

3. The system of claim 1, wherein the first sidewall display unit and the second sidewall display unit each further comprise a closed back panel.

4. The system of claim 1, wherein the first sidewall display unit and the second sidewall display unit each further comprise an open back panel.

5. The system of claim 1, wherein the first sidewall display unit and the second sidewall display unit are each further configured to receive a signage insert from a top port.

6. The system of claim 1, wherein the first sidewall display unit and the second sidewall display unit are each further configured to receive a signage insert from a side port.

7. The system of claim 1, further comprising a top display unit coupled to the display frame and configured to receive a third signage insert.

8. The system of claim 7, wherein the top display unit further comprises an open back.

9. The system of claim 7, wherein the top display unit further comprises a closed back.

10. The system of claim 1, wherein the display frame is a Sidekick display frame.

11. The system of claim 1, wherein the display frame is a wire frame display holder.

12. A system, comprising:
a first sidewall display unit configured to couple to a first side panel of a wire frame display holder;
a second sidewall display unit configured to couple to a second side panel of a wire frame display holder; and
wherein the first sidewall display unit and the second sidewall display unit are each further configured to receive a signage insert.

13. The system of claim 12, further comprising a top display unit configured to couple to a front panel of a wire frame display holed and to receive a signage insert.
